(19) United States
(12) Patent Application Publication
(10) Pub. No.: US 2016/0336126 A1
(43) Pub. Date: Nov. 17, 2016

(54) POLYESTER SWITCH OF FLEXIBLE CIRCUIT BOARD FOR KEYBOARD

(71) Applicant: JIANGSU TRANSIMAGE TECHNOLOGY CO., LTD, Yangzhou City (CN)

(72) Inventors: Weimin Zou, Yangzhou City (CN); Guozhi Guan, Yangzhou City (CN)

(21) Appl. No.: 15/000,326

(22) Filed: Jan. 19, 2016

(30) Foreign Application Priority Data
Nov. 20, 2014 (CN) 2014207029133

(51) Int. Cl. H01H 13/704

(52) U.S. Cl. CPC H01H 13/704

(57) ABSTRACT

A polyester thin-film switch of a flexible circuit board for a keyboard includes an upper layer polyester thin film, a middle layer and a lower layer polyester thin film, wherein the upper layer polyester thin film and the lower layer polyester thin film are plated with a matching printed circuit formed by copper wires with the width of 0.1 mm to 0.2 mm, the middle layer is an insulating layer, and the insulating layer is opened with a spacer hole for a key to pass through.

### TECHNICAL FIELD

The disclosure mainly relates to the field of a notebook computer, and more particular to the improvement of the structure of a polyester film switch in the notebook computer.

### BACKGROUND

A polyester thin-film switch of the existing notebook computer keyboard prints a silver wire on an upper layer polyester thin film and a lower layer polyester thin film, the middle is spaced with a middle layer, and the key is pressed to conduct. Due to the design limit of the keyboard, the printing processes on the polyester thin film are more (UV, jumper wire and the like). Not only the production cost is higher, but also the manufacturing yield is low, so the process of printing silver wire on the polyester thin-film needs to be changed.

### SUMMARY

Invention Object: aiming at the above-mentioned existing problems and shortages, the disclosure provides a polyester thin-film switch of a flexible circuit board for a keyboard, solving the difficulties of the polyester thin-film switch in the current industry that needs more processes and has complicated technology and low manufacturing yield, and saving the processes and a large number of auxiliary materials to reduce the manufacturing cost and improve the yield.

Technical Scheme: in order to achieve the abovementioned invention object, the disclosure adopts the technical scheme as follows: a polyester thin-film switch of a flexible circuit board for a keyboard includes an upper layer polyester thin film, a middle layer and a lower layer polyester thin film, wherein the upper layer polyester thin film and the lower layer polyester thin film are plated with a matching printed circuit formed by copper wires with the width of 0.1 mm to 0.2 mm, the middle layer is an insulating layer, and the insulating layer is opened with a spacer hole for a key to pass through.

Preferably, glue is bonded between the upper layer polyester thin film, the middle layer and the lower layer polyester thin film.

Preferably, the printed circuit does not have a jumper wire.

Beneficial effect: compared to the prior art, there are the following advantages: a brand-new design concept is adopted, plated copper with a thinner wire is used for replacing a silver wire in the current industry, so that the design routing is not limited by a keyboard mechanism any more, and surplus processes are not needed for connecting a circuit. The technological process is simplified, the badness of the production process is reduced, and the design and production cost is saved.

### BRIEF DESCRIPTION OF THE DRAWINGS

FIG. 1 is a schematic structural diagram of the utility model.

In the drawings there is, an upper layer polyester thin film 1, a middle layer 2, a lower layer polyester thin film 3, and glue 4.

### DESCRIPTION OF THE PREFERRED EMBODIMENTS

The invention will be illustrated hereinafter with reference to the drawings and the specific embodiments. It should be understood that these embodiments are only used for describing an embodiment of the invention but not limiting the scope of the invention. The modifications in various equivalent forms by those skilled in the art after reading the description below shall pertain to the scope limited by the claims of the application.

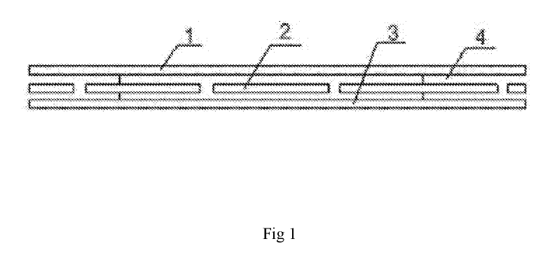

As shown in FIG. 1, a polyester thin-film switch of a flexible circuit board for a keyboard includes an upper layer polyester thin film, a middle layer and a lower layer polyester thin film, wherein the upper layer polyester thin film and the lower layer polyester thin film are plated with copper on the surface, and then are performed with layout corrosion so that the width of the copper metal wire is about 0.1 mm, and then reprinted with a carbon layer to form a circuit, and at last printed with glue; and the three layers are bonded together to form a flexible circuit board. A brand-new design concept is adopted, plated copper with a thinner wire is used for replacing a silver wire in the current industry, so that the design routing is not limited by a keyboard mechanism any more, and surplus processes are not needed for connecting a circuit. The technological process is simplified, the badness of the production process is reduced, and the design and production cost is saved.

1. A polyester thin-film switch of a flexible circuit board for a keyboard, comprising an upper layer polyester thin film, a middle layer and a lower layer polyester thin film, wherein the upper layer polyester thin film and the lower layer polyester thin film are plated with a matching printed circuit formed by copper wires with the width of 0.1 mm to 0.2 mm, the middle layer is an insulating layer, and the insulating layer is opened with a spacer hole for a key to pass through.

2. The polyester switch of the flexible circuit board for the keyboard according to claim 1, wherein glue is bonded between the upper layer polyester thin film, the middle layer and the lower layer polyester thin film.

3. The polyester thin-film switch of the flexible circuit board for the keyboard according to claim 1, wherein the printed circuit does not have a jumper wire.
